(19) United States
(12) Patent Application Publication
(10) Pub. No.: US 2021/0287397 A1
(43) Pub. Date: Sep. 16, 2021

(54) IMAGE CALIBRATION METHOD FOR IMAGING SYSTEM

(71) Applicant: CHENG MEI INSTRUMENT TECHNOLOGY CO., LTD., Zhubei City (TW)

(72) Inventors: Chin-Yu LIU, Zhubei City (TW); Cheng-En JIANG, Zhubei City (TW); Tung-Lin TANG, Zhubei City (TW); Chi-Yuan LIN, Zhubei City (TW); Hung Chun LO, Zhubei City (TW); Chao-Yu HUANG, Zhubei City (TW); Cheng-Tao TSAI, Zhubei City (TW)

(21) Appl. No.: 17/092,465

(22) Filed: Nov. 9, 2020

Related U.S. Application Data
(60) Provisional application No. 62/989,101, filed on Mar. 13, 2020.

(51) Int. Cl. G06T 7/73; G06T 7/00; G01N 21/27

(52) U.S. Cl. CPC G06T 7/74; G06T 7/97; G01N 2021/1765; G06T 2207/20212; G06T 2207/10056; G01N 21/274

(57) ABSTRACT

An image calibration method for imaging system is provided, including: specifying a detection area located in an image capture scope and the detection area having a unit to be tested; capturing a detection image respectively when the detection area is located in at least two locations within the image capture scope; combining the plurality of detection images and calculating to obtain a calibration figure; and applying the calibration figure to a captured image to complete the calibration. In this way, the calibration figure that adapt to the luminescent type and size of the unit to be tested can be obtained.

### CROSS-REFERENCES TO RELATED APPLICATIONS

This application claims priority to U.S. Provisional Patent Application No. 62/989,101 filed on Mar. 13, 2020, which is hereby incorporated by reference in its entirety.

### BACKGROUND OF THE INVENTION

### Field of the Invention

The present invention relates to an image calibration method for an imaging system, and in particular, relates to an image calibration method in which a detection area including a unit to be tested is photographed for many times to obtain a calibration figure so as to apply the calibration figure to an image captured subsequently for calibration.

### Descriptions of the Related Art

In the field of industrial production, many automated product inspection procedures (e.g., Automated Optical Inspection) are needed to ensure production quality and accelerate production efficiency. If the image light intensity is used as the detection basis, then the same object to be tested in different locations of the detection plane should produce the same image light intensity when it is detected so that the detection results are consistent and accurate. However, when taking an image with an image sensor, due to the vignetting effect of the lens, the light intensity of the same object to be tested at different locations in the image will be different (it is darker at the periphery of the image and brighter at the inside of the image), and the difference is more obvious when taking an image with a lens with a wide field of view, so it is necessary to calibrate the image before detection.

As shown in FIG. 1, generally, a uniform and reflective plane (mirror, whiteboard or standard) is used as a calibration piece 10, and after the calibration piece 10 is photographed once by the image sensor 20 in cooperation with the imaging system 30, the calibration amount of each location in the image captured by a single photographing and the calibration figure of the scope included in a single photographing can be obtained through the calculation of an external electronic device. When formal detection is carried out, this calibration figure is applied to obtain the calibrated detection result.

However, when the object to be tested is a luminescent sample 40 (e.g., a photoluminescent substance, an electroluminescent substance or a fluorescent substance.), unlike the calibration piece 10 which directly reflects light to the image sensor (as shown in FIG. 1), factors such as the luminescent type and the size of the luminescent sample 40 (as shown in FIG. 2 and FIG. 3) will make the calibration figure obtained from the calibration piece 10 unusable. In addition, as compared to the larger size of the object to be tested in the past detection field (which is for example greater than 100 μm), with the progress of science and technology, the smaller object to be tested (which is for example less than 50 μm) needs to be detected by an imaging system including a microscope or an imaging lens group of a higher magnification, the size change of the object to be tested will have a more severe impact, and the accuracy requirements will be greatly improved.

Accordingly, an urgent need exists in the art to maintain the detection accuracy in response to different sizes of objects to be tested.

### SUMMARY OF THE INVENTION

An objective of the present invention is to provide an image calibration method for an imaging system, which can detect objects to be tested of different sizes while maintaining detection accuracy.

To achieve the above objective, an image calibration method provided by the present invention comprises: specifying a detection area located in an image capture scope, the detection area comprising at least one unit to be tested; capturing respective detection images when the detection area is located in at least two locations within the image capture scope; combining the plurality of detection images and calculating to obtain a calibration figure; and applying the calibration figure to a captured image to complete the calibration.

In an embodiment, the step of capturing respective detection images when the detection area is located in at least two locations within the image capture scope comprises: moving an imaging lens group and a detection platform relative to each other to move the unit to be tested in the image capture scope.

In an embodiment, the step of capturing respective detection images when the detection area is located in at least two locations within the image capture scope comprises: capturing a detection image each time the unit to be tested moves to a different location in the image capture scope.

In an embodiment, the step of moving an imaging lens group and a detection platform relative to each other comprises: moving the imaging lens group in a serpentine manner relative to the detection platform or moving the detection platform in a serpentine manner relative to the imaging lens group.

In an embodiment, the detection image comprises a plurality of light intensity values, and the step of capturing respective detection images when the detection area is located in at least two locations within the image capture scope further comprises: respectively obtaining an average light intensity value of the light intensity values of the detection areas in the detection images.

In an embodiment, the step of combining the plurality of detection images and calculating to obtain a calibration figure comprises: obtaining a plurality of light intensity values between the average light intensity values of the detection areas by means of an arithmetic method.

In an embodiment, in the step of specifying a detection area located in an image capture scope, the detection area comprises at least two units to be tested.

In an embodiment, the unit to be tested is a light emitting part of a photoluminescent substance, an electroluminescent substance or a fluorescent substance.

In an embodiment, the at least two locations are separated from each other.

In an embodiment, the image calibration method provided by the present invention further comprises specifying another detection area located in an image capture scope, wherein the another detection area comprises another unit to be tested.

In an embodiment, the step of capturing respective detection images when the detection area is located in at least two locations within the image capture scope in the present invention further comprises: respectively obtaining a specified value of the light intensity values of the detection areas in the detection images, wherein the specified value includes a mode gray scale value or a specific gray scale range.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 to FIG. 3 are schematic views of the prior art;

FIG. 4 is a schematic view of an apparatus applicable to the method of the present invention;

FIG. 5 is a schematic top view of an LED applicable to the method of the present invention;

FIG. 6 is a schematic top view of a plurality of LEDs are arranged on a detection platform with a detection area;

FIG. 7 is a schematic view of a detection process of an image calibration method in a first preferred embodiment of the present invention;

FIG. 8 is a data table obtained when the unit to be tested is located at different locations;

FIG. 9 is a calibration figure obtained by calculating the data of FIG. 8;

FIG. 10 is a schematic top view of a plurality of LEDs are arranged on a detection platform with a detection area; and

FIG. 11 is a schematic view of a detection process of an image calibration method in a second preferred embodiment of the present invention.

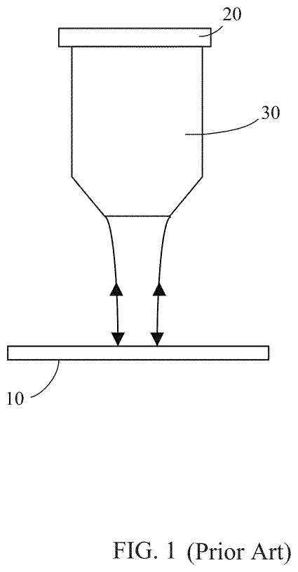

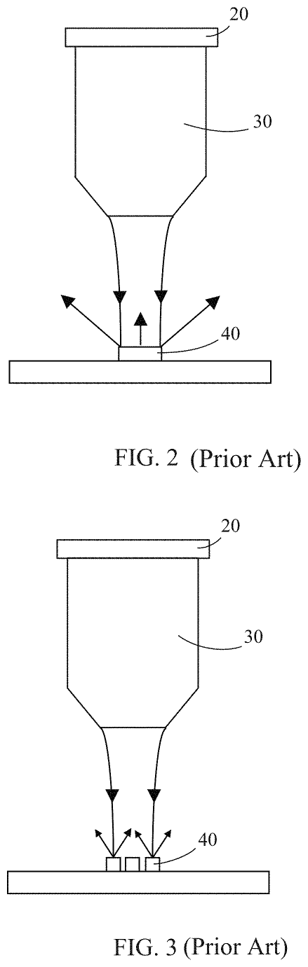

### DESCRIPTION OF THE PREFERRED EMBODIMENT

Hereinafter, specific embodiments according to the present invention will be specifically described; however, without departing from the spirit of the present invention, the present invention may be practiced in many different forms of embodiments, and the scope claimed in the present invention should not be interpreted as being limited to what stated in the specification. In addition, the technical content of each implementation in the above summary may also be used as the technical content of an embodiment, or as a possible variation of an embodiment.

Unless the context clearly indicates otherwise, singular forms “a” and “an” as used herein also include plural forms. When terms “including” or “comprising” are used in this specification, they are used to indicate the presence of the stated features, elements or components, and do not exclude the presence or addition of one or more other features, elements and components.

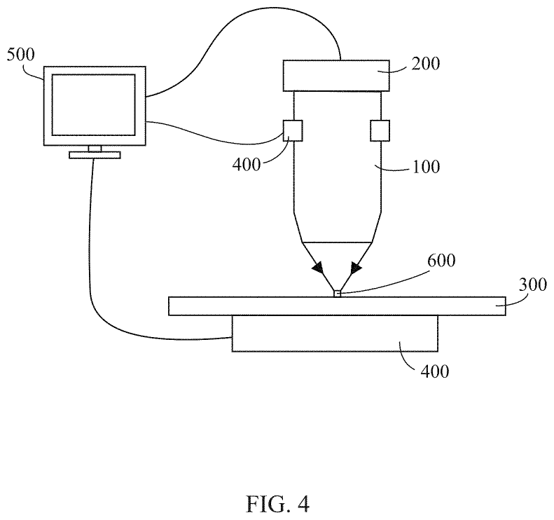

Referring to FIG. 4, an imaging system used in the present invention comprises a fluorescent imaging lens group 100 (which is called for short as an imaging lens group 100 hereinafter), which comprises elements such as a fluorescent light source, a fluorescent filter or the like to obtain a fluorescent image, and the fluorescent imaging lens group 100 may be for example a fluorescent microscope. The imaging lens group 100 may be connected with a detection apparatus, and the detection apparatus may comprise an image sensor 200, a detection platform 300, a mechanical device 400, and an electronic apparatus 500 or the like. The image sensor 200 may be used to capture an image observed through the imaging lens group 100, the detection platform 300 may be used to carry an object 600 to be tested, the mechanical device 400 may move the detection platform 300 or the imaging lens group 100 in a set direction, and the electronic apparatus 500 may be used to control the mechanical device 400, receive detection data from the image sensor 200 and perform arithmetic processing. The object 600 to be tested to which the method of the present invention is applicable may be a photoluminescent substance, an electroluminescent substance, a fluorescent substance or the like.

The image calibration method of the present invention may comprise the following main steps: (1) specifying a detection area 120 located in an image capture scope 110, the detection area 120 comprising at least one unit 130 to be tested; (2) capturing respective detection images when the detection area 120 is located in at least two locations Pn within the image capture scope 110; (3) combining the plurality of detection images and calculating to obtain a calibration figure; and (4) applying the calibration figure to a captured image to complete the calibration. The technical content of each step is described hereinafter by taking a light emitting diode (LED) as an example of the object 600 to be tested.

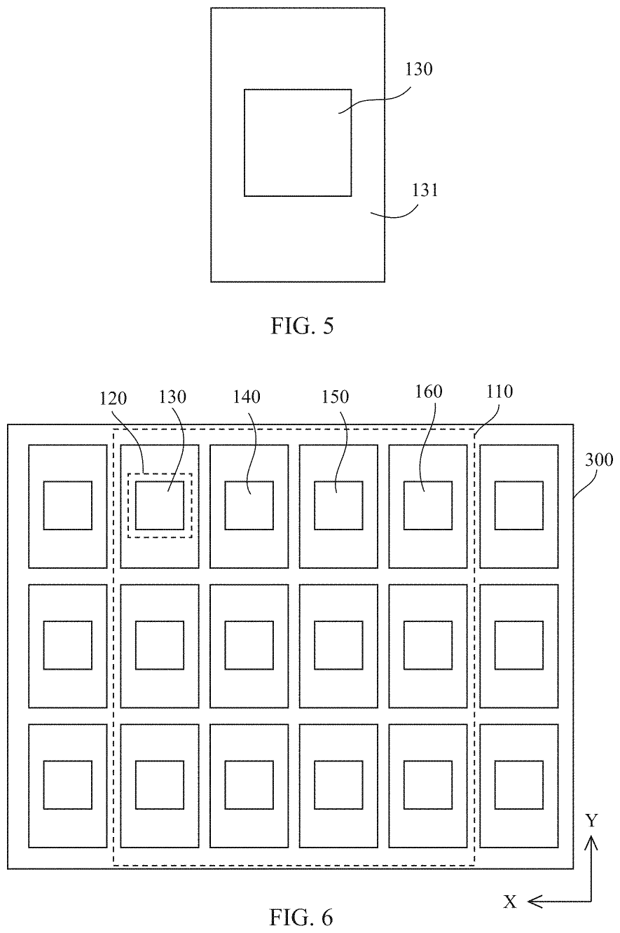

Please refer to FIG. 5, which is a schematic top view of an LED including a substrate 131 and a die, wherein the die may emit fluorescent light and serve as a unit 130 to be tested. According to different requirements of manufacturers, the unit 130 to be tested may also be a micro light emitting diode (Mini LED, Micro LED) or a light emitting part of other samples that may be excited to emit fluorescent light. Please refer to FIG. 6, which is a schematic top view of a plurality of LEDs arranged on the inspection platform 300. The imaging conditions (e.g., aperture, filter, magnification, etc.) of the imaging lens group 100 are fixed, so that the imaging lens group 100 has a fixed image capture scope 110 (the coverage area of a single photographing/a single capturing). The image capture scope 110 covers a plurality of units 130, 140, 150 and 160 to be tested on the detection platform 300, the detection area 120 is located in the image capture scope 110, and may comprise at least one unit 130 to be tested (all of which are known to be qualified units to be tested).

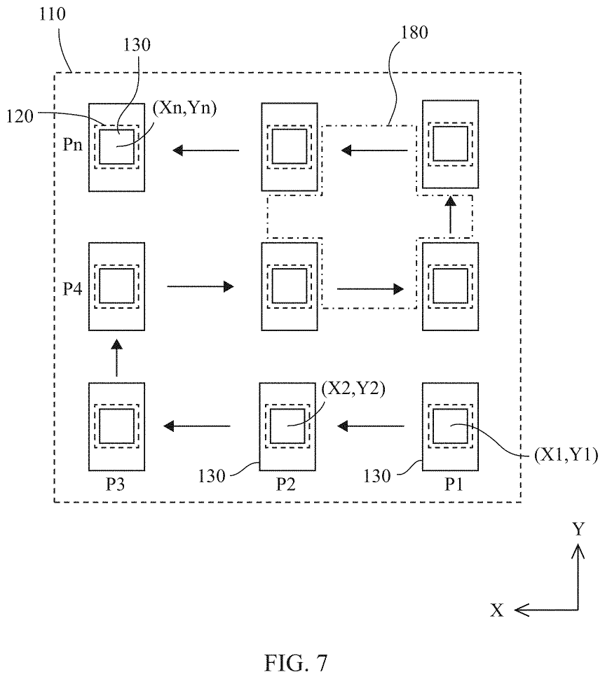

Please refer to FIG. 7 at the same time, which is a schematic view of a detection process of an image calibration method in a first preferred embodiment of the present invention. The electronic apparatus 500 transmits an instruction to the mechanical device 400 so that the mechanical device 400 controls the imaging lens group 100 and the detection platform 300 to move relative to each other. The imaging lens group or the detection platform may be moved independently or the imaging lens group and the detection platform are moved in different directions relative to each other at the same time so that the same unit 130 to be tested appears in different locations in the image capture scope 110. In this embodiment, the unit 130 to be tested moves in a serpentine manner relative to the imaging lens group 100, and repeatedly appears at different locations in the image capture scope 110. A detection image is captured each time the unit 130 to be tested moves from one location to another location of different locations, so as to serve as data for subsequent arithmetic processing.

Basically, the detection images of the unit 130 to be tested captured at different locations in the image capture scope 110 spaced apart by a certain distance may be provided to the electronic apparatus 500 for calculation, and the locations may be for example located at diagonal locations in the image capture scope 110. Preferably, the unit 130 to be tested repeatedly appears at a plurality of different locations Pn (n may be replaced by any symbol or number, meaning different locations) in the image capture scope 110 to obtain a plurality of detection images. In detail, the unit 130 to be tested appears in a first location P1, a second location P2, . . . , a n^{th} location Pn in sequence, N detection images are captured, and the locations Pn are separated from each other by a distance, e.g., a distance of the size of at least one unit 130 to be tested, and do not overlap with each other, so as to obtain a better capture speed. However, according to different detection requirements, adjacent locations Pn may also be close to or adjacent to each other, or even partially overlap with each other, so as to obtain better detection accuracy.

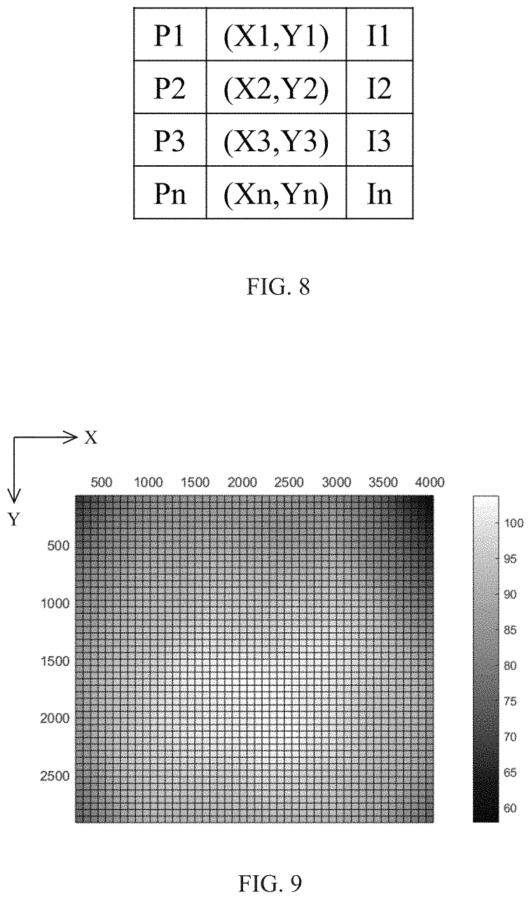

The detection image obtained after capturing contains a plurality of light intensity values (gray scale values), and the specified detection area 120 may be larger than, smaller than or equal to the unit 130 to be tested. After transmitting the data of the light intensity values of the detection area 120 to the electronic apparatus 500, an average light intensity value (average gray scale value) representing the center coordinates (Xn, Yn) (n may be replaced by any symbol or number corresponding to the capture location, which also means different locations) of the detection area 120 in each detection image may be obtained after calculation to form a data table. As shown in FIG. 8, the first row of the table shows the average gray scale value (H) of the center coordinates (X1, Y1) of the detection area 120 in the detection image when the specified unit 130 to be tested is located at the first location P1; the second row of the table shows the average gray scale value (2) of the center coordinates (X2, Y2) of the detection area 120 in the detection image when the same unit 130 to be tested is located at the second location P2; and so on. Then, a calculation method, such as a regional interpolation method, may be used to combine a plurality of detection images to obtain a calibration figure (as shown in FIG. 9). Furthermore, the light intensity values between the center coordinates of a plurality of detection areas 120, such as the light intensity values in the area 180 (the scope not covered by the detection area), may be supplemented by the operation of the electronic apparatus 500, so as to further obtain a calibration amount at any location in the whole image capture scope 110 and obtain a calibration figure in the image capture scope 110.

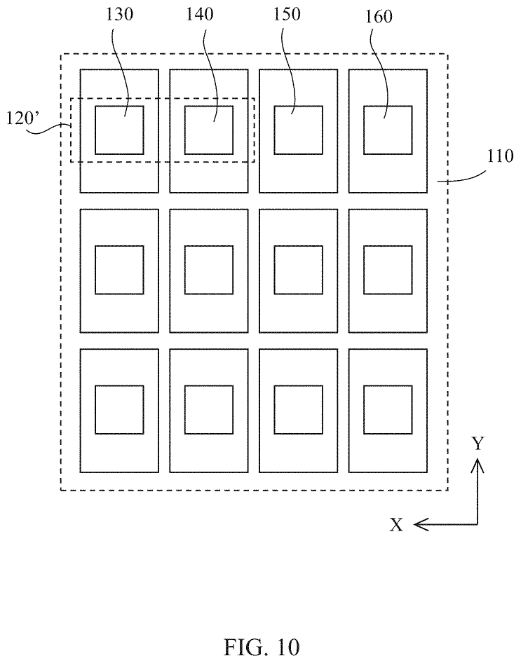

As shown in FIG. 10, the detection area 120′ of a method according to a second preferred embodiment of the present invention comprises a plurality of units 130 to be tested which are adjacent to each other. For example, as shown in FIG. 10, the detection area for a single capture may comprise two units 130 to be tested (both of which are known to be qualified units to be tested).

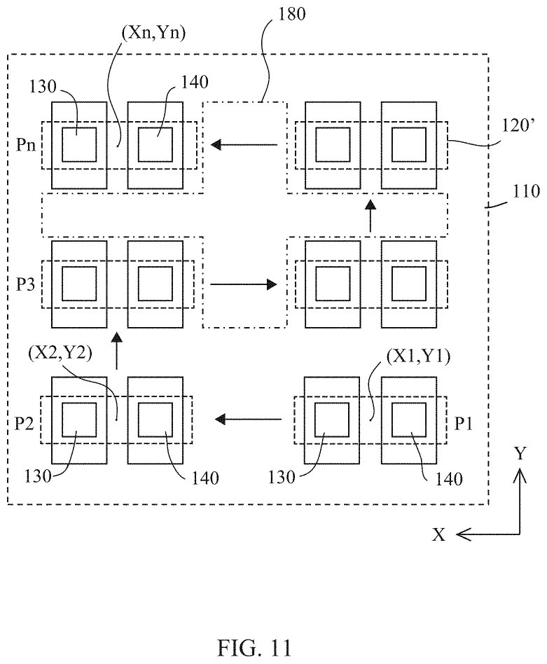

Please continue to refer to FIG. 11, which is a schematic view of a detection process of the image calibration method in the second preferred embodiment. The units 130 and 140 to be tested repeatedly appear at different locations in the image capture scope, e.g., at locations P1, P2, . . . , Pn in sequence, and N detection images are captured. Then, in this embodiment, an average light intensity value (average gray scale value) of the center coordinates of the detection area 120′ in each detection image may also be obtained after receiving and calculating by the electronic apparatus, and a data table as shown in FIG. 8 is formed, wherein the difference lies in that the average light intensity value in this embodiment is the average intensity value of multiple units to be tested. Because the detection area 120′ in this embodiment covers a larger area, as compared to the method of covering only one unit to be tested, it may obtain a calibration figure in the image capture scope 110 faster without excessively sacrificing the detection accuracy.

In addition, after the data of the above-mentioned light intensity values (gray scale values) are transmitted to the electronic apparatus 500 for calculation, a specified value representing each detection area 120 may also be obtained, and the specified value may be a mode gray scale value or a specific gray scale range, and a data table is formed for further calculation to obtain a calibration figure.

After obtaining the calibration figure, the calibration figure may be applied to a captured image of the unit 130 to be tested with the same size and luminescent type (the coverage area of this image may be equal to the image capture scope 110 or the size thereof is not limited) during formal detection so as to obtain the calibrated result. In this way, the screening operation of products to be tested may be carried out accurately according to the calibrated image.

The method of the present invention may further comprise specifying another detection area located in an image capture scope, wherein the another detection area comprises another unit to be tested. Furthermore, before the step (4) is executed, the steps (1) to (3) are repeated with another unit to be tested that is known to be qualified. Taking the first embodiment as an example, after capturing respective detection images when the unit 130 to be tested is located in at least two locations within the image capture scope 120, another unit 140 to be tested that is located in the image capture scope 110 is specified to capture respective detection images of the unit 140 to be tested in at least two locations in the image capture scope 110. Multiple detection mages may be obtained respectively at different locations in the image capture scope 110 for the unit 130 to be tested and the unit 140 to be tested. For example, N detection images may be obtained for the unit 130 to be tested from locations P1a, P2a, . . . , Pna and calculated to obtain a calibration figure, while N detection images may be further obtained for the unit 140 to be tested from locations P1b, P2b, . . . , Pnb and calculated to obtain another calibration figure. In this way, the calibration figures obtained from the units 130 and 140 to be tested are further averaged to improve the calibration accuracy. In other words, the user may specify a plurality of units to be tested according to the requirement of accuracy, and obtain two or more calibration figures to complete the calibration figures for formal detection, thereby achieving more accurate and precise detection requirements.

The above steps may also be applied to the second embodiment: for example, specifying and controlling a plurality of units 130 and 140 to be tested to appear at a plurality of locations Pna in the image capture scope 110 to obtain N detection images and calculate to obtain a calibration figure, specifying and controlling a plurality of units 150 and 160 to be tested to appear at a plurality of locations Pnb in the image capture scope 110 to further obtain N detection images and calculate to obtain another calibration figure. In other words, the detection area 120′ of this embodiment has a larger coverage area without changing the number of times of capturing, so that a calibration figure of the image capturing scope 110 may be obtained more efficiently without excessively sacrificing detection accuracy, with only the coverage area of the detection image being larger.

According to the above descriptions, the present invention specifies the detection area including one or more units to be tested, and the detection area appears in the different locations of the image capture scope to provide the data which may be calculated to obtain a calibration figure. As compared to the prior art in which the calibration figure is obtained by using a calibration piece, the method of the present invention may obtain the calibration figure adaptable for the different luminescent types and size of the unit to be tested during formal detection, thereby providing better detection accuracy.

What is claimed is:

1. An image calibration method for an imaging system, comprising:
specifying a detection area located in an image capture scope, the detection area comprising at least one unit to be tested;
capturing respective detection images when the detection area is located in at least two locations within the image capture scope;
combining the plurality of detection images and calculating to obtain a calibration figure; and
applying the calibration figure to a captured image to complete the calibration.

2. The image calibration method of claim 1, wherein the step of capturing respective detection images when the detection area is located in at least two locations within the image capture scope comprises: moving an imaging lens group and a detection platform relative to each other to move the unit to be tested in the image capture scope.

3. The image calibration method of claim 2, wherein the step of capturing respective detection images when the detection area is located in at least two locations within the image capture scope comprises: capturing a detection image each time the unit to be tested moves to one of the at least two locations in the image capture scope.

4. The image calibration method of claim 2, wherein the step of moving an imaging lens group and a detection platform relative to each other comprises: moving the imaging lens group in a serpentine manner relative to the detection platform or moving the detection platform in a serpentine manner relative to the imaging lens group.

5. The image calibration method of claim 1, wherein the detection image comprises a plurality of light intensity values, and the step of capturing respective detection images when the detection area is located in at least two locations within the image capture scope further comprises: respectively obtaining an average light intensity value of the light intensity values of the detection areas in the detection images.

6. The image calibration method of claim 5, wherein the step of combining the plurality of detection images and calculating to obtain a calibration figure comprises:
obtaining a plurality of light intensity values between the average light intensity values of the detection areas by means of an arithmetic method.

7. The image calibration method of claim 1, wherein in the step of specifying a detection area located in an image capture scope, the detection area comprises at least two units to be tested.

8. The image calibration method of claim 1, wherein the unit to be tested is a light emitting part of a photoluminescent substance, an electroluminescent substance or a fluorescent substance.

9. The image calibration method of claim 1, wherein the at least two locations are separated from each other.

10. The image calibration method of claim 1, further comprising specifying another detection area located in an image capture scope, wherein the another detection area comprises another unit to be tested.

11. The image calibration method of claim 1, wherein the detection image comprises a plurality of light intensity values, and the step of capturing respective detection images when the detection area is located in at least two locations within the image capture scope further comprises: respectively obtaining a specified value of the light intensity values of the detection areas in the detection images.

12. The image calibration method of claim 11, wherein the step of combining the plurality of detection images and calculating to obtain a calibration figure comprises:
obtaining a plurality of light intensity values between the specified values of the detection areas by means of an arithmetic method.

13. The image calibration method of claim 12, wherein the specified value includes a mode gray scale value or a specific gray scale range.
